(19) United States
(12) Patent Application Publication
(10) Pub. No.: US 2026/0257668 A1
(43) Pub. Date: Sep. 3, 2026

(54) VEHICLE, CONTROL METHOD FOR VEHICLE, AND STORAGE MEDIUM

(71) Applicant: HONDA MOTOR CO., LTD., Tokyo (JP)

(72) Inventors: Kazuki Yamano, Tokyo (JP); Yuki Hara, Tokyo (JP)

(73) Assignee: HONDA MOTOR CO., LTD., Tokyo (JP)

(21) Appl. No.: 19/549,012

(22) Filed: Feb. 25, 2026

(30) Foreign Application Priority Data
Feb. 28, 2025 (JP) 2025-031268

(51) Int. Cl. B60W 30/06; B60W 30/18

(52) U.S. Cl. CPC B60W 30/06; B60W 30/18009; B60W 2556/10; B60W 2556/40

(57) ABSTRACT

A vehicle includes: an information acquirer; a route guide; and a controller configured to control an operation of the vehicle including autonomous parking. The controller is configured to, in a case where the destination set in the route guide is a parking lot and the parking lot is a parking lot in which the vehicle is required to be stopped at an entrance, start a first control based on the state information such that at least one operation included in the first control including one or more operations of the vehicle is completed before the vehicle arrives at a stop position of the entrance, and activate a control mode for performing the autonomous parking after the first control is completed and the vehicle stops at the stop position, and wait for an input of a predetermined operation for instructing the vehicle to perform the autonomous parking.

### CROSS REFERENCE TO RELATED APPLICATIONS

This application is based upon and claims the benefit of priority from prior Japanese patent application No. 2025-31268, filed on February 28, 2025, the entire contents of which are incorporated herein by reference.

### TECHNICAL FIELD

The present disclosure relates to a vehicle, a control method for a vehicle, and a storage medium storing a program.

### BACKGROUND ART

In recent years, active efforts have been made to provide access to a sustainable transportation system in consideration of vulnerable people among traffic participants. In order to implement the above, research and development on further improving safety and convenience of traffic by research and development related to driving assistance technology have been performed.

An autonomous parking method described in CN117698697A relates to autonomous parking in a parking lot in which a gate is installed at an entrance. The autonomous parking method stops a vehicle in front of the gate based on a current position of the vehicle during an autonomous driving process along a stored route. Image information in front of the vehicle is acquired by an in-vehicle camera, and whether the gate is open is determined by image recognition. When it is determined that the gate is opened, the vehicle continues to travel along the route.

### SUMMARY OF INVENTION

In the parking lot in which the gate is installed at the entrance, typically, an entrance ticket is issued. A user of the vehicle stops the vehicle in front of the gate, opens a window of the vehicle, receives the entrance ticket, and closes the window. When the autonomous parking is performed, the user is required to perform additional operations such as a setting operation and a start operation for the autonomous parking. Aspects of the present disclosure relate to reducing an operation burden on a user.

According to an aspect of the present disclosure, there is provided a vehicle including:

an information acquirer configured to acquire state information and surrounding information of the vehicle;

a route guide configured to perform route guidance from a current position of the vehicle to a destination; and

a controller configured to control an operation of the vehicle including autonomous parking, in which

the controller is configured to,

in a case where the destination set in the route guide is a parking lot and in a case where the parking lot is a parking lot in which the vehicle is required to be stopped at an entrance,

start a first control based on the state information such that at least one operation included in the first control including one or more operations of the vehicle is completed before the vehicle arrives at a stop position of the entrance, and

activate a control mode for performing the autonomous parking after the first control is completed and the vehicle stops at the stop position, and wait for an input of a predetermined operation for instructing the vehicle to perform the autonomous parking.

According to another aspect of the present disclosure, there is provided a control method for a vehicle including an information acquirer configured to acquire state information and surrounding information of the vehicle, a route guide configured to perform route guidance from a current position of the vehicle to a destination, and a controller configured to control an operation of the vehicle including autonomous parking, the control method including:

in a case where the destination set in the route guide is a parking lot and in a case where the parking lot is a parking lot in which the vehicle is required to be stopped at an entrance,

starting, by the controller, a first control based on the state information such that at least one operation included in the first control including one or more operations of the vehicle is completed before the vehicle arrives at a stop position of the entrance, and

activating, by the controller, a control mode for performing the autonomous parking after the first control is completed and the vehicle stops at the stop position, and waiting for an input of a predetermined operation for instructing the vehicle to perform the autonomous parking.

According to another aspect of the present disclosure, there is provided a non-transitory computer-readable storage medium storing a program causing a computer to execute the control method.

According to the present disclosure, an operation burden on a user can be reduced.

### BRIEF DESCRIPTION OF DRAWINGS

Exemplary embodiment(s) of the present invention will be described in detail based on the following figures, wherein:

FIG. 1 is a side view of an example of a vehicle for illustrating an embodiment of the present disclosure;

FIG. 2 is a plan view of the vehicle of FIG. 1;

FIG. 3 is a functional block diagram of the vehicle of FIG. 1;

FIG. 4 is a flowchart illustrating an autonomous parking process performed by a control unit of the vehicle of FIG. 1; and

FIG. 5 illustrates an example of an operation screen for autonomous parking.

### DESCRIPTION OF EMBODIMENTS

An example of a vehicle for illustrating an embodiment of the present disclosure will be described with reference to the accompanying drawings. The drawings are viewed from directions of reference numerals. In the present specification and the like, in order to simplify and clarify the description, a front-rear direction, a left-right direction, and an upper-lower direction are described according to directions viewed from a driver of a vehicle. In the drawings, a front side of the vehicle is illustrated as Fr, a rear side is illustrated as Rr, a left side is illustrated as L, a right side is illustrated as R, an upper side is illustrated as U, and a lower side is illustrated as D.

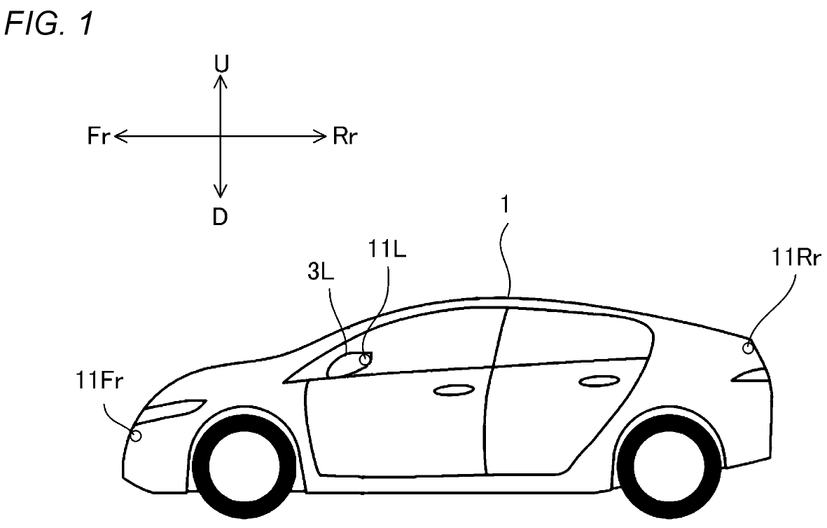

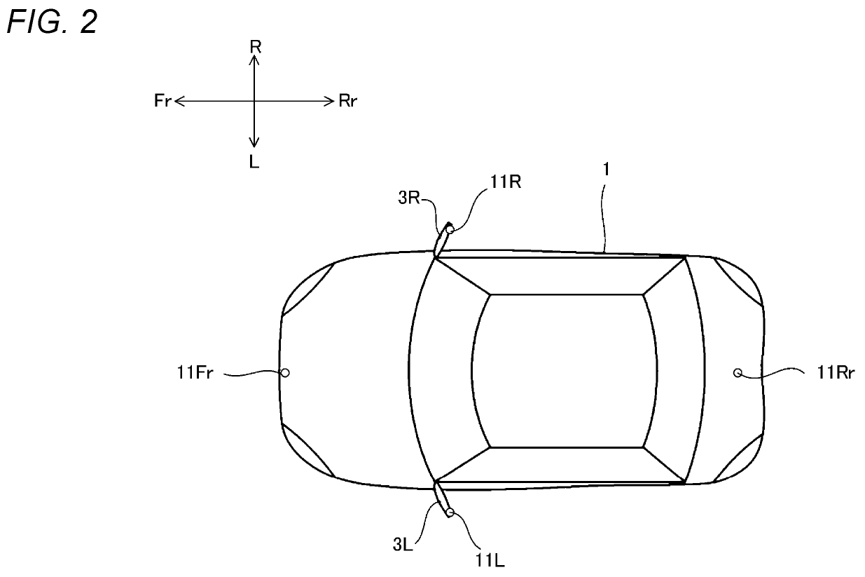

A vehicle 1 illustrated in FIGS. 1 and 2 is a four-wheeled automobile including a pair of left and right front wheels and a pair of left and right rear wheels. A drive source of the vehicle 1 is an internal combustion engine such as a gasoline engine or a diesel engine, an electric motor, or a combination of the internal combustion engine and the electric motor. Both the pair of left and right front wheels and the pair of left and right rear wheels may be driven by the drive source, or any one of the pair of left and right front wheels and the pair of left and right rear wheels may be driven by the drive source. Alternatively, both the pair of left and right front wheels and the pair of left and right rear wheels may be steered wheels that are steerable, or any one of the pair of left and right front wheels and the pair of left and right rear wheels may be steered wheels.

The vehicle 1 includes side mirrors 3L and 3R. The side mirrors 3L and 3R are mirrors for a driver to check a rear side and rear lateral sides and are provided on outer sides of front seat doors of the vehicle 1.

The vehicle 1 includes a front camera 11Fr, a rear camera 11Rr, a left side camera 11L, and a right-side camera 11R. The front camera 11Fr is a digital camera (image sensor) that images a front side of the vehicle 1 and is provided at a front portion of the vehicle 1. The rear camera 11Rr is a digital camera that images a rear side of the vehicle 1 and is provided on a rear portion of the vehicle 1. The left side camera 11L is a digital camera that images a left side of the vehicle 1 and is provided on the side mirror 3L on the left side of the vehicle 1. The right-side camera 11R is a digital camera that images a right side of the vehicle 1 and is provided on the side mirror 3R on the right side of the vehicle 1.

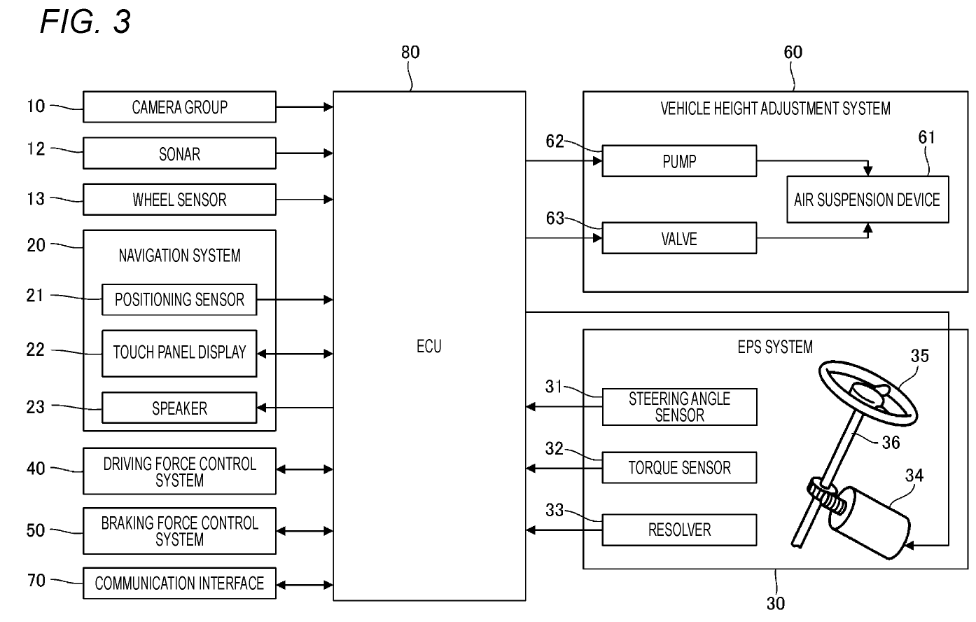

As illustrated in FIG. 3, the vehicle 1 includes a sensor group, a navigation system 20, an electric power steering (EPS) system 30, a driving force control system 40, a braking force control system 50, a vehicle height adjustment system 60, a communication interface 70, and an electronic control unit (ECU) 80 that integrally controls the devices.

The sensor group acquires various detection values used for controls of the vehicle 1. A camera group 10 including the front camera 11Fr, the rear camera 11Rr, the left side camera 11L, and the right-side camera 11R is also included in the sensor group. The sensor group further includes the camera group 10 and a sonar 12 for acquiring surrounding information of the vehicle 1, and a wheel sensor 13, a positioning sensor 21, and a steering angle sensor 31 for acquiring state information of the vehicle 1.

The front camera 11Fr, the rear camera 11Rr, the left side camera 11L, and the right-side camera 11R acquire a front image, a rear image, a left side image, and a right-side image of the vehicle 1. The ECU 80 performs image recognition on images acquired by the front camera 11Fr, the rear camera 11Rr, the left side camera 11L, and the right-side camera 11R, detects road markings drawn on a road surface around the vehicle 1, obstacles present around the vehicle 1, and the like, and identifies types of the detected road markings, obstacles, and the like. The ECU 80 generates a surrounding image of the vehicle 1 using the images acquired by the front camera 11Fr, the rear camera 11Rr, the left side camera 11L, and the right-side camera 11R. The surrounding image is, for example, a two-dimensional image or a three-dimensional image in which the vehicle 1 is overlooked. Images of the vehicle 1 prepared in advance may be combined with the surrounding image.

The sonar 12 emits sound waves to the surroundings of the vehicle 1 and receives a reflected sound. The ECU 80 detects an obstacle or the like present in the surroundings of the vehicle 1 based on a direction of the received reflected sound and a time from the emission of the sound waves to the reception of the reflected sound and detects a direction and a distance in which the detected obstacle or the like is present.

The sensor group may include, as a sensor that acquires the surrounding information of the vehicle 1, other sensors such as a radar and a light detection and ranging or laser imaging detection and ranging (Lidar).

The wheel sensor 13 detects rotation angles of the respective wheels including the pair of left and right front wheels and the pair of left and right rear wheels of the vehicle 1. The wheel sensor 13 is, for example, an angle sensor or a displacement sensor, and outputs a pulse signal each time the wheel rotates by a predetermined angle. The ECU 80 calculates the rotation angle and a rotation speed of each wheel from the pulse signal output from the wheel sensor 13 and further calculates a speed and a moving distance of the vehicle 1.

The navigation system 20 includes a positioning sensor 21 that detects a current position of the vehicle 1, a touch panel display 22, a speaker 23, and a memory (not illustrated) that stores map information. The positioning sensor 21 is, for example, a global positioning system (GPS) sensor. The navigation system 20 guides a travel route to a destination to a user of the vehicle 1 based on position information of the vehicle 1 detected by the positioning sensor 21 and the map information stored in the memory. The guidance is presented to the user through the touch panel display 22 or the speaker 23. The touch panel display 22 functions as one of an input interface to the ECU 80 and an output destination of a display process and/or a notification process performed by the ECU 80. The speaker 23 functions as an output destination of the notification process performed by the ECU 80.

The EPS system 30 includes the steering angle sensor 31, a torque sensor 32, a resolver 33, and an EPS motor 34. The steering angle sensor 31 detects a steering angle of a steering wheel 35. The torque sensor 32 detects a torque applied to the steering wheel 35. The resolver 33 detects a rotation angle of the EPS motor 34. The ECU 80 drives the EPS motor 34 to apply a driving force or a reaction force to a steering column 36 coupled to the steering wheel 35 based on the steering angle, the torque, and the rotation angle, thereby assisting an operation of the occupant on the steering wheel 35.

Under a control of the ECU 80, the driving force control system 40 controls a driving force of the vehicle 1 by operating the drive source or the like of the vehicle 1 in response to an accelerator pedal operation or a shift operation of the occupant. Under the control of the ECU 80, the braking force control system 50 controls a braking force of the vehicle 1 by operating a brake mechanism or the like of the vehicle 1 in response to a brake pedal operation or the shift operation of the occupant.

The vehicle height adjustment system 60 includes an air suspension device 61 that supports the pair of left and right front wheels and the pair of left and right rear wheels, a pump 62 that supplies an air pressure to the air suspension device 61, and a valve 63 that adjusts the air pressure of the air suspension device 61. The pump 62 and the valve 63 operate under the control of the ECU 80, increase a vehicle height of the vehicle 1 by supplying the air pressure to the air suspension device 61, and decrease the vehicle height of the vehicle 1 by releasing the air pressure of the air suspension device 61.

The communication interface 70 performs wireless communication with another communication device under the control of the ECU 80. The other communication device is a base station, a communication device of another vehicle, an information terminal such as a smartphone carried by the occupant of the vehicle 1, or the like.

The ECU 80 includes a processor and a memory that stores programs to be executed by the processor and various types of data to be used during the execution of the programs. By the processor operating according to the programs, the ECU 80 realizes the various functions described above, such as steering operation assistance, the driving force control, the braking force control, and the vehicle height adjustment. The ECU 80 can realize autonomous traveling and autonomous parking based on cooperation of the sensor group, the navigation system 20, the EPS system 30, the driving force control system 40, the braking force control system 50, and the vehicle height adjustment system 60. The ECU 80 may include a plurality of processors divided for respective functions such as the steering operation assistance, the driving force control, and the braking force control.

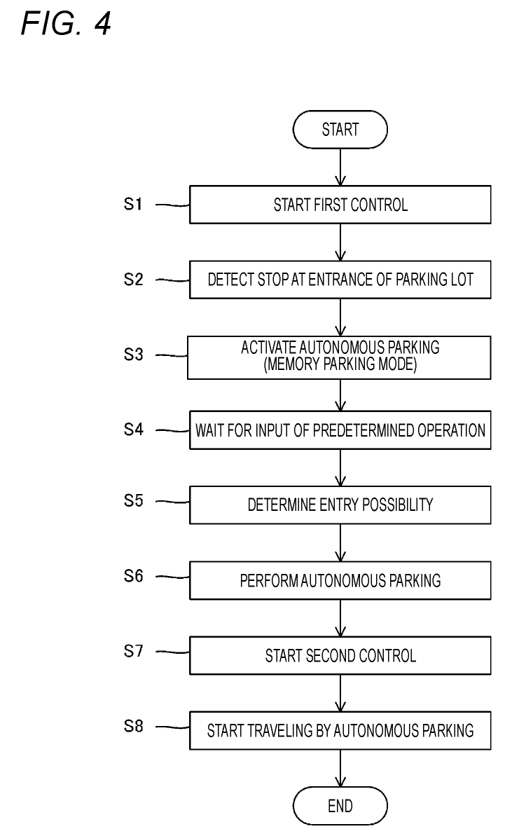

FIG. 4 illustrates a process of performing the autonomous parking in a parking lot in which the vehicle 1 is require to be stopped at the entrance.

The parking lot in which the vehicle is required to be stopped at the entrance is, for example, a parking lot in which a gate is installed at the entrance thereof. An entrance ticket is issued at the entrance, and the gate is opened when the user of the vehicle receives the entrance ticket. In this case, the vehicle is permitted to enter the parking lot when the gate is opened, that is, when entry to the parking lot is possible. The issuance of the entrance ticket and the opening and closing of the gate may be performed by an automatic ticketing machine installed at the entrance or by an attendant of the parking lot. Instead of issuing and receiving the entrance ticket, identification information such as a barcode displayed on an information terminal carried by the user of the vehicle may be registered in a parking management system of the parking lot, and the gate is opened upon completion of the registration. The gate may be opened on condition that the vehicle has stopped at the entrance. In this case, when the vehicle becomes able to enter the parking lot, the vehicle is not necessarily permitted to enter the parking lot, and it may be required to receive the entrance ticket and register the identification information.

It is assumed that a parking lot PA is set in the navigation system 20 as a destination, and the map information stored in the memory of the navigation system 20 includes additional information indicating that the parking lot PA is a parking lot in which the vehicle is required to be stopped at the entrance.

First, the ECU 80 starts the first control based on the state information of the vehicle 1 such that at least one operation included in a first control including one or more operations of the vehicle 1 is completed before the vehicle 1 arrives at a stop position of the entrance of the parking lot PA (step S1). The operation of the vehicle 1 included in the first control is opening of a window, volume reduction of in-vehicle audio, adjustment of the vehicle height, and the like, and an operation required time from the start to the end of each operation is stored in the memory of the ECU 80 in advance. In addition, the ECU 80 estimates a required arrival time for the vehicle 1 to arrive at the stop position from the current position. The required arrival time can be estimated based on the distance along the scheduled traveling route from the current position to the parking lot PA and a current speed of the vehicle 1.

For example, when the operation required time for the opening of the window is 5 seconds, the ECU 80 starts opening the window at a timing before the estimated required arrival time becomes 5 seconds. When the in-vehicle audio is in operation, the ECU 80 reduces the volume of the in-vehicle audio in accordance with the opening of the window. Since the window is opened when the vehicle 1 arrives at the stop position of the entrance of the parking lot PA, the user can smoothly receive the entrance ticket. In addition, since the volume of the in-vehicle audio is low, it is possible to reduce a possibility that the user fails to hear the voice guidance at the entrance and to prevent sound leakage to the outside of the vehicle. When a wiper is operating due to rainy weather or the like, the ECU 80 may cause the touch panel display 22 to display a screen for allowing the user to confirm whether to open the window, and opens the window based on an operation input to the touch panel display 22.

After the vehicle 1 stops at the stop position of the entrance of the parking lot PA, the ECU 80 controls the vehicle height adjustment system 60 to adjust a vehicle height of the vehicle 1. In a vehicle type such as a sport utility vehicle (SUV) or a minivan, a hip position from a road surface to a seat surface is generally set to be relatively high. By lowering the vehicle height of the vehicle 1, accessibility to a ticket issuance port of the automatic ticketing machine through the window is improved, and the user can smoothly receive the entrance ticket. The ECU 80 may cause the touch panel display 22 to display a screen for allowing the user to confirm whether to adjust the vehicle height and may adjust the vehicle height based on an operation input to the touch panel display 22. The adjustment of the vehicle height may be completed before the vehicle 1 arrives at the stop position of the entrance of the parking lot PA as in the case of opening the window or reducing the volume of the in-vehicle audio but is preferably performed after the vehicle 1 stops from the viewpoint of reducing a load on the air suspension device 61.

The ECU 80 detects that the vehicle 1 has stopped at the stop position of the entrance of the parking lot PA (step S2) and activates a control mode for performing the autonomous parking of the vehicle 1 after the first control is completed (step S3). The ECU 80 has a memory parking mode and a patrol parking mode as the control mode of the autonomous parking.

The memory parking mode is a control mode for parking the vehicle 1 at a parking position registered in the memory. The ECU 80 performs the autonomous parking in the memory parking mode based on a route from a parking start position where the vehicle 1 has traveled in the past to the parking position, information necessary for the autonomous traveling of the vehicle 1 along the route, and the map information. The information necessary for the autonomous traveling of the vehicle 1 is state information such as a position, a speed, and a steering angle of the vehicle 1 and surrounding information such as a division line and an obstacle defining a parking space, and the ECU 80 stores these pieces of information in the memory of the ECU 80 in association with the map information.

The patrol parking mode is a control mode in which the vehicle detects a vacant parking space while patrolling around the parking lot, and the vehicle 1 is parked in the vacant parking space. The vehicle patrols around the parking lot based on the map information, and the ECU 80 detects the vacant parking space based on the surrounding information, automatically generates a travel route suitable for parking in the vacant parking space, and performs the autonomous parking in the patrol parking mode based on the generated travel route.

Here, it is assumed that the vehicle 1 has been parked in one or more parking spaces of the parking lot PA in the past, and the ECU 80 stores the route from the stop position of the entrance of the parking lot PA to the parking position at that time and the information necessary for the autonomous traveling of the vehicle 1 along the route in the memory in association with the map information. Since the vehicle 1 has been parked in the one or more parking spaces of the parking lot PA in the past, the memory parking mode is activated in step S3.

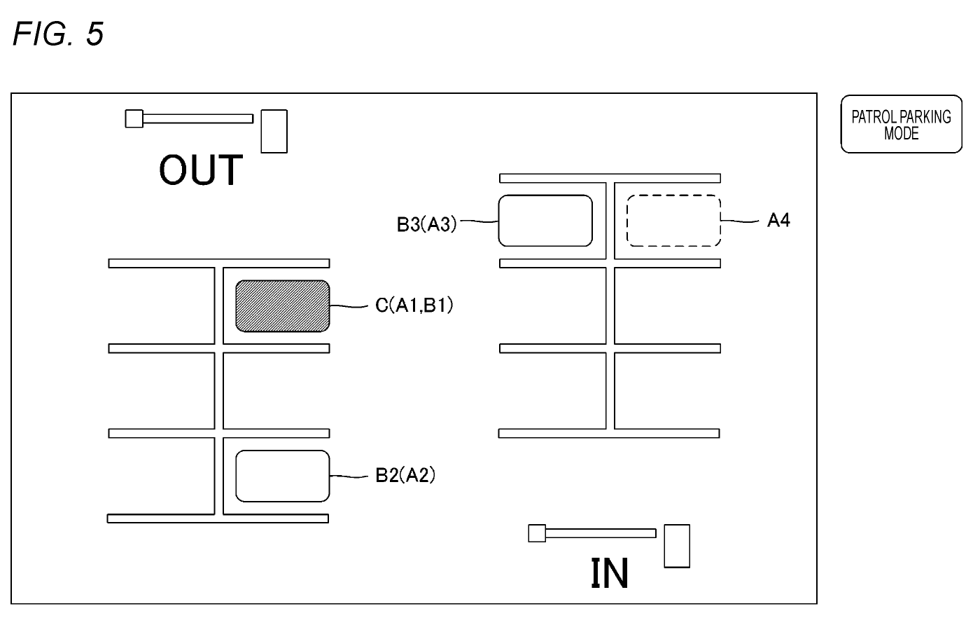

The operation screen illustrated in FIG. 5 is an operation screen for the autonomous parking in the memory parking mode, and a detailed map of the parking lot PA based on the map information is displayed on the operation screen. The map includes road markings of an entrance IN and an exit OUT, division lines that define parking spaces, and the like.

The ECU 80 extracts the candidate parking positions B1, B2, and B3 from parking positions A1, A2, A3, and A4 stored in the memory based on a preset extraction condition. Then, the ECU 80 displays the extracted candidate parking positions B1, B2, and B3 in a first highlighted manner on the map on the operation screen. The extraction condition is, for example, a condition that a distance from the entrance IN is short, a distance to the exit OUT is short, stationary steering is not performed, reverse turning is less, a turning rate is small, parking is easy (a size of the parking space and a road width of the travel route), the user frequently uses the space, a roof is present, and another vehicle frequently stops. The number of extraction conditions is not limited to one, and a plurality of extraction conditions may be combined. The ECU 80 allows the user to change the extraction condition. The display in the first highlighted manner for the extracted candidate parking positions B1, B2, and B3 is performed by, for example, making a color, the thickness, a line type, and the like of the frame lines surrounding the candidate parking positions B1, B2, and B3 different from the frame lines surrounding the parking positions A1, A2, A3, and A4 stored in the memory.

The ECU 80 receives an operation of selecting a target parking position C for parking the vehicle 1 by the autonomous parking from the candidate parking positions B1, B2, and B3, and performs a display in a second highlighted manner for the selected target parking position C. The selection operation is performed by, for example, a touch operation on the candidate parking positions B1, B2, and B3 displayed in the first highlighted manner. The display in the second highlighted manner for the target parking position C may be performed by, for example, making the color, the thickness, the line type, and the like of the frame lines surrounding the target parking position C different from the frame line surrounding the candidate parking positions B1, B2, and B3 and the frame line surrounding the parking positions A1, A2, A3, and A4 stored in the memory, or may be performed by coloring the inside of the frame lines.

A switching button for instructing switching from the memory parking mode to the patrol parking mode is also displayed on the operation screen of the autonomous parking in the memory parking mode. Upon receiving a touch operation on the switching button, the ECU 80 switches the control mode to the patrol parking mode. When the vehicle 1 has not been parked in the parking lot PA in the past, the ECU 80 may activate the patrol parking mode in step S3.

The ECU 80 displays the operation screen illustrated in FIG. 5 on the touch panel display 22 and waits for an input of a predetermined operation for instructing the vehicle to perform the autonomous parking (step S4). The predetermined operation can be an operation of returning any one of states of the vehicle 1 changed by the first control to a state before the first control is performed, and is, for example, a switch operation of closing the window opened by the first control.

The predetermined operation for instructing the vehicle to perform the autonomous parking may be an operation on an operation screen of the autonomous parking displayed on the touch panel display 22, and may be, for example, a touch operation on the target parking position C displayed in the second highlighted manner. The ECU 80 determines the target parking position C based on the touch operation on the target parking position C and starts the autonomous parking in the memory parking mode. The predetermined operation may be a touch operation on a switching button for instructing switching to the patrol parking mode. The ECU 80 starts the autonomous parking in the patrol parking mode based on the touch operation on the switching button.

In parallel with the input waiting of the predetermined operation, the ECU 80 determines whether the vehicle 1 can enter the parking lot PA based on the surrounding information (step S5). For example, the ECU 80 performs the image recognition on the front image acquired by the front camera 11Fr, recognizes whether the gate of the entrance is opened, and determines that the entry to the parking lot is possible when the gate is opened.

Then, the ECU 80 performs the autonomous parking in the set control mode (the memory parking mode or the patrol parking mode) at a later timing of a timing at which the predetermined operation for instructing the vehicle to perform the autonomous parking is input and a timing at which the entry to the parking lot PA is possible (step S6).

When starting the traveling by the autonomous parking, the ECU 80 performs a second control of returning the state of the vehicle 1 changed by the first control of step S1 to a state before the first control is performed (step S7) and then starts the traveling by the autonomous parking (step S8). For example, when the window is opened by the first control, the ECU 80 closes the window by the second control. When the vehicle height is decreased by the first control, the ECU 80 increases the vehicle height by the second control. The traveling by the autonomous parking may be started after a target operation of the second control is completed, or the traveling by the autonomous parking may be started before the target operation of the second control is completed. However, with respect to the adjustment of the vehicle height, from the viewpoint of reducing the load on the air suspension device 61, the traveling by the autonomous parking is preferably started after the adjustment of the vehicle height is completed.

When starting the traveling by the autonomous parking, the ECU 80 changes a shift position to drive and starts the autonomous parking when the shift position of the vehicle 1 is set to parking. Furthermore, when starting the traveling by the autonomous parking, the ECU 80 releases a parking brake and starts the autonomous parking when the parking brake of the vehicle 1 is operating. As described above, when the traveling by the autonomous parking is started, the state of the vehicle 1 changed by the first control in step S1 is returned to the state before the first control is performed by the control of the ECU 80, the shift position is changed to the drive, and the parking brake is released, so that an operation burden on the user is reduced.

In step S6, assuming that the autonomous parking in the memory parking mode is performed, the ECU 80 determines whether the parking at the target parking position C is possible based on the surrounding information. Examples of the case where the parking at the target parking position C is impossible include a case where another vehicle is parked at the target parking position C. When it is determined that parking at the target parking position C is impossible, the ECU 80 causes the touch panel display 22 to display text or an image indicating that the parking at the target parking position C is impossible and changes the target parking position to another candidate parking position. The change to the other candidate parking position may be automatically performed by the ECU 80 according to the priority of the extraction condition, or may be performed by a touch operation on the candidate parking position displayed in the first highlighted manner on the operation screen illustrated in FIG. 5.

When the target parking position C after the start of the autonomous parking is changed a predetermined number of times with the number of parking positions stored in the memory as an upper limit, the ECU 80 switches from the memory parking mode to the patrol parking mode. When switching to the patrol parking mode, the ECU 80 may cause the touch panel display 22 to display a screen for allowing the user to confirm whether to perform the switching of the control mode and perform the switching of the control mode based on an operation input to the touch panel display 22.

When a predetermined condition is satisfied during the autonomous parking in the patrol parking mode, the ECU 80 cancels the autonomous parking and transfers the authority of driving of the vehicle 1 to the user. The predetermined condition is, for example, a case where an elapsed time from the start of the autonomous parking in the patrol parking mode exceeds a predetermined time and/or a travel distance exceeds a predetermined distance.

The embodiment of the present invention has been described above, but the present invention is not limited to the embodiment described above, and modifications, improvements, and the like can be made as appropriate. In the present description, at least the following matters are described. Although corresponding constituent elements or the like in the embodiment described above are shown in parentheses, the present invention is not limited thereto.

(1) A vehicle including:

an information acquirer (camera group 10, wheel sensor 13, positioning sensor 21, steering angle sensor 31) configured to acquire state information and surrounding information of the vehicle;

a route guide (20) configured to perform route guidance from a current position of the vehicle to a destination; and

a controller (ECU 80) configured to control an operation of the vehicle including autonomous parking, in which

the controller is configured to,

in a case where the destination set in the route guide is a parking lot and in a case where the parking lot is a parking lot in which the vehicle is required to be stopped at an entrance,

start a first control based on the state information such that at least one operation included in the first control including one or more operations of the vehicle is completed before the vehicle arrives at a stop position of the entrance, and

activate a control mode for performing the autonomous parking after the first control is completed and the vehicle stops at the stop position, and wait for an input of a predetermined operation for instructing the vehicle to perform the autonomous parking.

According to the vehicle of the above (1), since when the vehicle 1 arrives at the stop position of the entrance of the parking lot, at least one operation included in the first control is completed, and the control mode for performing the autonomous parking is automatically activated after the vehicle stops at the stop position, an operation burden on the user is reduced.

(2) The vehicle according to (1), in which

the controller performs, before starting traveling by the autonomous parking, a second control for returning a state of the vehicle changed in the first control to a state before the first control is performed.

According to the vehicle of the above (2), since the state of the vehicle changed by the first control is automatically returned to the state before the first control is performed by the second control, the operation burden on the user can be reduced.

(3) The vehicle according to (2), in which

the first control and the second control include adjustment of a vehicle height, and

the controller is configured to,

perform the adjustment of the vehicle height of the first control after the vehicle stops at the stop position, and

start the traveling by the autonomous parking after the adjustment of the vehicle height of the second control is completed.

According to the vehicle of the above (3), it is possible to reduce the load on the vehicle due to the adjustment of the vehicle height.

(4) The vehicle according to any one of (1) to (3), in which

the controller is configured to

determine whether entry of the vehicle to the parking lot is possible based on the surrounding information, and

perform the autonomous parking when the predetermined operation is input and when the entry of the vehicle to the parking lot is possible.

According to the vehicle of the above (4), the autonomous parking can be appropriately performed regardless of an order of a timing at which the predetermined operation is input and a timing at which the vehicle can enter the parking lot, and the operation burden on the user can be reduced.

(5) The vehicle according to (4), further including

a storage that stores a route from a parking start position to a parking position along which the vehicle has traveled in a past and information necessary for autonomous traveling of the vehicle along the route in association with map information used for the route guidance, in which

the control mode includes a memory parking mode in which the autonomous parking is performed based on the map information, the route and the information stored in the storage, and

the controller performs the autonomous parking in a case where a target parking position is selected from the parking position stored in the storage when the predetermined operation is input and when the entry of the vehicle to the parking lot is possible.

(6) The vehicle according to (5), in which

the controller is configured to

determine whether parking at the target parking position is possible based on the surrounding information during the autonomous parking in the memory parking mode, and

change the target parking position to another parking position stored in the storage in a case where it is determined that the parking of the vehicle at the target parking position is impossible.

According to the vehicle of the above (5), the autonomous parking can be appropriately performed regardless of an order of the timing at which the predetermined operation is input, the timing at which the vehicle can enter the parking lot, and a timing at which the target parking position is selected, and the operation burden on the user can be reduced.

According to the vehicle of the above (6), the autonomous parking can be continued by changing the target parking position.

(7) The vehicle according to (6), in which

the control mode further includes a patrol parking mode in which the vehicle patrols around the parking lot based on the map information, detects a vacant parking space based on the surrounding information, and parks in the vacant parking space, and

the controller is configured to switch from the memory parking mode to the patrol parking mode when the target parking position is changed a predetermined number of times.

According to the vehicle of the above (7), the autonomous parking can be continued by switching to the patrol parking mode.

(8) The vehicle according to (7), in which

when a predetermined condition is satisfied during the autonomous parking in the patrol parking mode, the controller is configured to cancel the autonomous parking and transfer authority of driving of the vehicle to a user of the vehicle.

According to the vehicle of the above (8), even when the autonomous parking is difficult, the parking can be continued by transferring the authority of driving to the user.

(9) The vehicle according to (4), in which

the control mode further includes a patrol parking mode in which the vehicle patrols around the parking lot based on the map information used for the route guidance, detects a vacant parking space based on the surrounding information, and parks in the vacant parking space, and

when a predetermined condition is satisfied during the autonomous parking in the patrol parking mode, the controller is configured to cancel the autonomous parking and transfer authority of driving of the vehicle to a user of the vehicle.

According to the vehicle of the above (9), even when the autonomous parking is difficult, the parking can be continued by transferring the authority of driving to the user.

(10) A control method for a vehicle including an information acquirer configured to acquire state information and surrounding information of the vehicle, a route guide configured to perform route guidance from a current position of the vehicle to a destination, and a controller configured to control an operation of the vehicle including autonomous parking, the control method including:

in a case where the destination set in the route guide is a parking lot and in a case where the parking lot is a parking lot in which the vehicle is required to be stopped at an entrance,

starting, by the controller, a first control based on the state information such that at least one operation included in the first control including one or more operations of the vehicle is completed before the vehicle arrives at a stop position of the entrance, and

activating, by the controller, a control mode for performing the autonomous parking after the first control is completed and the vehicle stops at the stop position, and waiting for an input of a predetermined operation for instructing the vehicle to perform the autonomous parking.

According to the control method of the above (10), since when the vehicle 1 arrives at the stop position of the entrance of the parking lot PA, at least one operation included in the first control is completed, and the control mode for performing the autonomous parking is automatically activated after the vehicle stops at the stop position, the operation burden on the user is reduced.

(11) A non-transitory computer-readable storage medium storing a program causing a computer to execute the control method according to (10).

What is claimed is:

1. A vehicle comprising:
an information acquirer configured to acquire state information and surrounding information of the vehicle;
a route guide configured to perform route guidance from a current position of the vehicle to a destination; and
a controller configured to control an operation of the vehicle including autonomous parking, wherein
the controller is configured to,
in a case where the destination set in the route guide is a parking lot and in a case where the parking lot is a parking lot in which the vehicle is required to be stopped at an entrance,
start a first control based on the state information such that at least one operation included in the first control including one or more operations of the vehicle is completed before the vehicle arrives at a stop position of the entrance, and
activate a control mode for performing the autonomous parking after the first control is completed and the vehicle stops at the stop position and wait for an input of a predetermined operation for instructing the vehicle to perform the autonomous parking.

2. The vehicle according to claim 1, wherein
the controller performs, before starting traveling by the autonomous parking, a second control for returning a state of the vehicle changed in the first control to a state before the first control is performed.

3. The vehicle according to claim 2, wherein
the first control and the second control include adjustment of a vehicle height, and
the controller is configured to,
perform the adjustment of the vehicle height of the first control after the vehicle stops at the stop position, and
start the traveling by the autonomous parking after the adjustment of the vehicle height of the second control is completed.

4. The vehicle according to claims claim 1, wherein
the controller is configured to
determine whether entry of the vehicle to the parking lot is possible based on the surrounding information, and
perform the autonomous parking when the predetermined operation is input and when the entry of the vehicle to the parking lot is possible.

5. The vehicle according to claim 4, further comprising
a storage that stores a route from a parking start position to a parking position along which the vehicle has traveled in a past and information necessary for autonomous traveling of the vehicle along the route in association with map information used for the route guidance, wherein
the control mode includes a memory parking mode in which the autonomous parking is performed based on the map information, the route and the information stored in the storage, and
the controller performs the autonomous parking in a case where a target parking position is selected from the parking position stored in the storage when the predetermined operation is input and when the entry of the vehicle to the parking lot is possible.

6. The vehicle according to claim 5, wherein
the controller is configured to
determine whether parking at the target parking position is possible based on the surrounding information during the autonomous parking in the memory parking mode, and
change the target parking position to another parking position stored in the storage in a case where it is determined that the parking of the vehicle at the target parking position is impossible.

7. The vehicle according to claim 6, wherein
the control mode further includes a patrol parking mode in which the vehicle patrols around the parking lot based on the map information, detects a vacant parking space based on the surrounding information, and parks in the vacant parking space, and
the controller is configured to switch from the memory parking mode to the patrol parking mode when the target parking position is changed a predetermined number of times.

8. The vehicle according to claim 7, wherein
when a predetermined condition is satisfied during the autonomous parking in the patrol parking mode, the controller is configured to cancel the autonomous parking and transfer an authority of driving of the vehicle to a user of the vehicle.

9. The vehicle according to claim 4, wherein
the control mode further includes a patrol parking mode in which the vehicle patrols around the parking lot based on the map information used for the route guidance, detects a vacant parking space based on the surrounding information, and parks in the vacant parking space, and
when a predetermined condition is satisfied during the autonomous parking in the patrol parking mode, the controller is configured to cancel the autonomous parking and transfer authority of driving of the vehicle to a user of the vehicle.

10. A control method for a vehicle including an information acquirer configured to acquire state information and surrounding information of the vehicle, a route guide configured to perform route guidance from a current position of the vehicle to a destination, and a controller configured to control an operation of the vehicle including autonomous parking, the control method comprising:
in a case where the destination set in the route guide is a parking lot and in a case where the parking lot is a parking lot in which the vehicle is required to be stopped at an entrance,
starting, by the controller, a first control based on the state information such that at least one operation included in the first control including one or more operations of the vehicle is completed before the vehicle arrives at a stop position of the entrance, and
activating, by the controller, a control mode for performing the autonomous parking after the first control is completed and the vehicle stops at the stop position and waiting for an input of a predetermined operation for instructing the vehicle to perform the autonomous parking.

11. A non-transitory computer-readable storage medium storing a program causing a computer to execute the control method according to claim 10.
